(19) United States
(12) Patent Application Publication
(10) Pub. No.: US 2026/0186452 A1
(43) Pub. Date: Jul. 2, 2026

(54) Reinforcement Learning for Controlling an Industrial Process

(71) Applicant: ABB Schweiz AG, Baden (CH)

(72) Inventors: Soroush Rastegarpour, Västerås (SE); Alf Isaksson, Västerås (SE); Nandkishor Kubal, Pune (IN)

(73) Assignee: ABB Schweiz AG, Baden (CH)

(21) Appl. No.: 19/468,464

(22) Filed: Feb. 3, 2026

Related U.S. Application Data
(63) Continuation of application No. PCT/EP2024/072662, filed on Aug. 9, 2024.

(51) Int. Cl. G05B 13/02

(52) U.S. Cl. CPC G05B 13/0265

(57) ABSTRACT

The present disclosure relates to a method of training a machine learning agent for controlling an industrial process in an industrial plant. The method comprises, to the agent, inputting simulated values of process variables, from a simulation of the industrial process using a model of the industrial process, and example values of disturbance variables. An adjustment is inputted to the simulation, whereby the simulated PV values depend on said adjustment. The agent, in response to the simulated and example values, outputs values of manipulated variables. The MV values are used in the simulation, the simulation updating the simulated PV values. A cost of the simulated industrial process is estimated when using the MV values. As a function of the estimated cost, a reward is fed to the agent.

### CROSS-REFERENCE TO RELATED APPLICATIONS

The instant application claims priority to International Patent Application No. PCT/EP 2024/072662, filed Aug. 9, 2024, and to Indian Patent Application No. 202341054462, filed Aug. 14, 2023, each of which is incorporated herein in its entirety by reference.

### FIELD OF THE DISCLOSURE

The present disclosure generally relates to a method of training a machine learning agent by a Reinforcement Learning (RL) algorithm for controlling an industrial process in an industrial plant.

### BACKGROUND OF THE INVENTION

Reinforcement Learning (RL) is a type of machine learning in which an intelligent agent is trained to obtain a maximum cumulative reward. The agent takes actions in an environment, e.g. an industrial process, which is interpreted into a reward and a representation of the state of the environment, which are fed back into the agent. A reinforcement learning agent typically interacts with its environment in discrete time steps. At each step, the agent receives the current state and reward. It then chooses an action from a set of available actions, which is subsequently sent to the environment.

RL machine learning may be used for control of an industrial process, instead of (or in addition to) Real-Time Optimization (RTO) and Advanced Process Control (APC).

### BRIEF SUMMARY OF THE INVENTION

The present disclosure generally describes a training for a more robust RL agent for control of an industrial process. According to an aspect of the present disclosure, there is provided a method of, by a Reinforcement Learning algorithm, training a machine learning agent for controlling an industrial process in an industrial plant. The method comprises, for each of a plurality of training episodes: to the agent, inputting simulated values of process variables, from a simulation of the industrial process using a model of said industrial process, which process variables can be sensed or estimated in the plant, and example values of disturbance variables, which may or may not be sensed in the plant; the agent, in response to the inputted simulated and example values, outputting values of manipulated variables, which may typically be actuated (or controlled) in the plant; using the outputted values of the manipulated variables in said simulation of the industrial process, the simulation updating the simulated values of the process variables used in the simulation; estimating a cost of the simulated industrial process when using the values of the manipulated variables; and as a function of the estimated cost, feeding a reward to the agent. Thus, the trained agent is obtained after said episodes. The method further comprises, in each of at least some of the episodes, to the simulation inputting at least one adjustment of the model of the industrial process, the input simulated values of the process variables depending on said adjustment.

According to another aspect of the present invention, there is provided a system configured for, by a Reinforcement Learning algorithm, training a machine learning agent for controlling an industrial process in an industrial plant. The system comprises processing circuitry, and storage storing instructions executable by said processing circuitry whereby said system is operative to perform an embodiment of the method of the present disclosure.

According to another aspect of the present invention, there is provided a computer program product comprising computer-executable components for causing a system to perform an embodiment of the method of the present disclosure when the computer-executable components are run on processing circuitry comprised in the system.

By also training the agent on adjustments of the model of the industrial process, the agent may be able to control the industrial process under non-ideal conditions, e.g. when uncontrolled disturbances affect the process (e.g. a chemical reaction process in a reactor). In some embodiments, the adjustment may be an adjustment of a parameter (e.g. a constant) in an equation of the model. For instance, the parameter may be a reaction rate constant, which is under normal operating conditions known and constant, but which may, e.g. in response to a disturbance to the process such as high or low ambient temperature which may not be controlled, vary somewhat. In some other embodiments, the adjustment may be adding at least one equation to the model and/or removing at least one equation from the model, and/or adding at least one term to an equation of the model and/or removing at least one term from an equation of the model. For example, under non-ideal conditions, a secondary (typically unwanted) reaction may take place in addition to the (wanted) primary reaction, in which case the adjustment may be to include equation(s) also for this secondary reaction.

Which adjustments to introduce to the model may be decided based on the probability of different adjustments occurring in the industrial process, e.g. as calculated from historical process data. If an adjustment has historically had a high probability of occurring, that adjustment may be made to the model during the training for more episodes (iterations) of the training than an adjustment which has historically had a lower probability of occurring.

### BRIEF DESCRIPTION OF THE SEVERAL VIEWS OF THE DRAWING(S)

FIG. 1 is a schematic block diagram of an industrial plant in accordance with some embodiments of the present disclosure.

FIG. 2 is a schematic diagram of a system configured for, by a Reinforcement Learning algorithm, training a machine learning agent for controlling an industrial process in an industrial plant, in accordance with some embodiments of the present disclosure.

FIG. 3 is a schematic block diagram of a system configured for training a machine learning agent, in accordance with some embodiments of the present disclosure.

FIG. 4 is a schematic flow chart of some embodiments of the method of the present disclosure.

### DETAILED DESCRIPTION OF THE INVENTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

As used herein, process variables (PV) are variables that depend on the process and are time dependent. They can typically be monitored (i.e. sensed or measured over time), why sensed values of the PVs may be fed to the trained agent when used for controlling the industrial process in the plant. As used herein, disturbance variables (DV) are external input variables which cannot be controlled. As used herein, manipulated variables (MV) are variables which are changed by the agent, e.g. via a PID regulator or the like. As a simple illustrative example, a PV may be the temperature in a room, a DV may be the outdoor temperature, and an MV may be a control signal to a heater in the room. In this example, a parameter may relate to the transfer of heat from the heater to the air in the room.

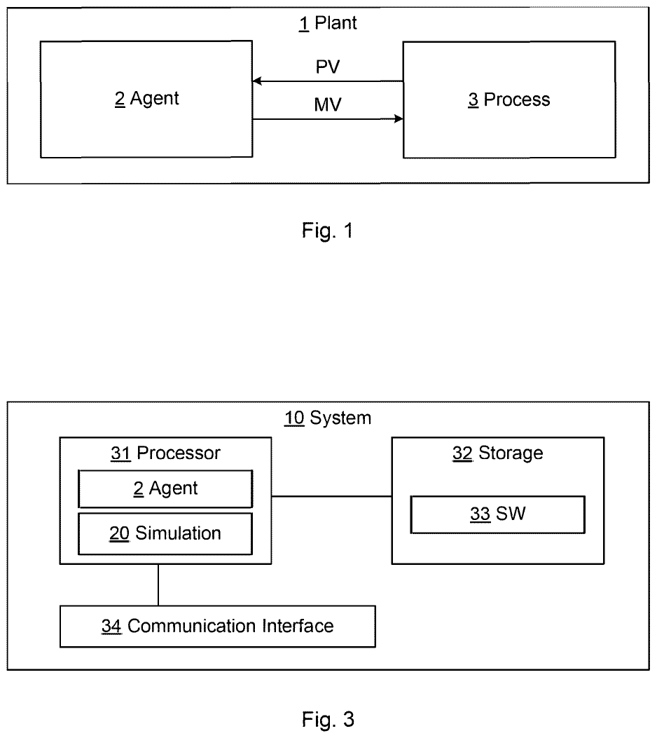

FIG. 1 illustrates an industrial plant 1 in which an industrial process 3 is running. The process 3 is controlled by a trained agent 2. The agent is fed sensed values of process variables (PV) in the process 3, and in response thereto, outputs values of manipulated variables (MV) to the process. Typically, the MVs are controlled to assume the outputted values by means of a PID regulator or the like.

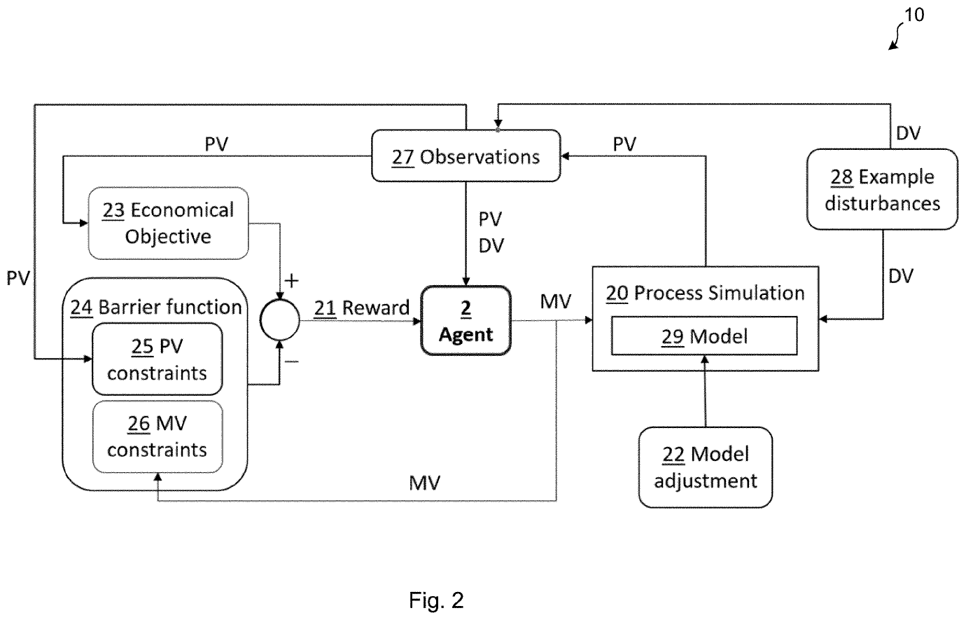

FIG. 2 illustrates a system 10 configured for, by an RL algorithm, training a machine learning agent 2 for controlling the industrial process 3 in an industrial plant 1. The RL includes receiving a reward 21 in response to feeding values, selected by the agent 2) of MV to the simulation 20, where the MV values are selected with the objective of achieving the highest possible cumulative reward. Values of PV and DV, the PV values resulting from the MV values, are fed to the agent 2 in one or several sampling iterations during each episode of the training. The PV and DV values may be determined based on observations 27, e.g. by a human and/or computer observer or by a sensor.

PV values may be obtained from the simulation 20. DV values may be obtained from example disturbances 28, e.g. defined by a human or computer operator. PV values are fed to the agent 2, and DV values are fed to both the agent 2 and to the simulation 20, whereby the disturbance associated with the DV values is simulated in the simulation 20.

The simulation 20 is based at least partly on a model 29 of the industrial process. Additionally, the simulation may be based on e.g. structural information about the plant 1. In at least some of the training episodes, the model 29 is adjusted by inputting model adjustment(s) 22 to the model 29. In some embodiments of the present invention, the at least one adjustment 22 comprises an adjustment of a parameter in the model 29. In some embodiments, the adjustment 22 of the parameter is based on an estimated probability of the parameter assuming different values. For instance, the probability of the parameter assuming the different values may be estimated based on historical data of the industrial process 3. Additionally or alternatively, in some embodiments of the present invention, the at least one adjustment 22 comprises an adjustment by adding at least one equation to the model 29 and/or removing at least one equation from the model 29, and/or adding at least one term to an equation of the model 29 and/or removing at least one term from an equation of the model 29. Also the adjustment 22 by adding and/or removing a term and/or an equation may be based on a probability of some non-ideal situations occurring in the process 3, e.g. based on historical data of the industrial process 3. For example, if it is known from the historical data from the plant 1 that a secondary reaction may occur in the industrial process 3, the model 29 may be adjusted to reflect this, whereby the agent 2 is trained to handle also this situation.

The reward 21 is, in each episode (e.g. for each sampling in the episode), a function of the estimated cost of the simulated industrial process 3 during that episode. In some embodiments of the present invention, the reward is calculated based on an economic objective function 23 related to an economic target for the industrial process 3 relative to the estimated cost. In some embodiments, the reward is also calculated based on a barrier function 24 related to a predefined constraint 25 for at least one of the process variables PV and/or a predefined constraint 26 for at least one of the manipulated variables MV. For instance if e.g. a reactor temperature, which may be a PV sensed in the process 3, should not exceed a predefined threshold (i.e. PV constraint 25), the barrier function 24 may punish the agent 2 by significantly reducing the reward 21 if the reactor temperature exceeds the threshold in the simulation 20.

FIG. 3 schematically illustrates an embodiment of the system 10 of the present disclosure. The system 10 comprises processing circuitry 31 e.g. a central processing unit (CPU). The processing circuitry 31 may comprise one or a plurality of processing units in the form of microprocessor(s). However, other suitable devices with computing capabilities could be comprised in the processing circuitry 31, e.g. an application specific integrated circuit (ASIC), a field programmable gate array (FPGA) or a complex programmable logic device (CPLD). The processing circuitry 31 is configured to run one or several computer program(s) or software (SW) 33 stored in a storage 32 of one or several storage unit(s) e.g. a memory. The storage unit is regarded as a computer readable means 32, forming a computer program product together with the SW 33 stored thereon as computer-executable components, and may e.g. be in the form of a Random Access Memory (RAM), a Flash memory or other solid state memory, or a hard disk, or be a combination thereof. The processing circuitry 31 may also be configured to store data in the storage 32, as needed. When executing at least a part of the SW 33, the processing circuitry 31 may provide the agent 2 and/or simulation 20 discussed herein. The system 10 may also comprise a communication interface 34 for communication with other parts of the system 10 or external of the system, e.g. a human-machine interface (HMI).

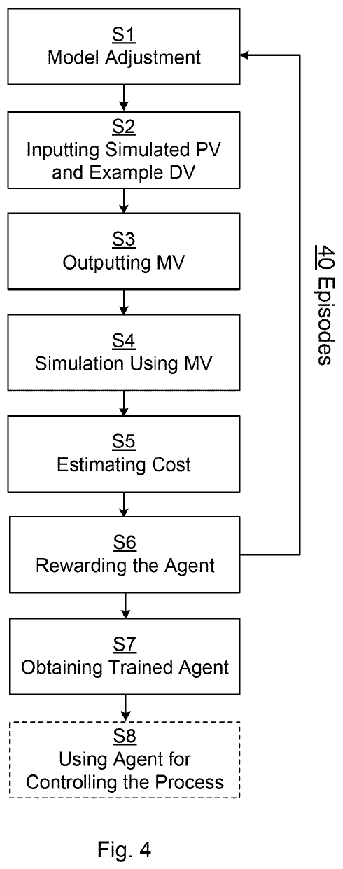

FIG. 4 is a schematic flow chart illustrating some embodiments of the method of the present disclosure. The method is for, by RL, training the machine learning agent 2 for controlling the industrial process 3 in an industrial plant 1. The method comprises performing, in relation to a simulation 20 of the process 3, a plurality of training iterations, which are herein called episodes 40, before the trained agent 2 is obtained S7. The trained agent 2 may then be used S8 for controlling the industrial process 3 in the plant 1 (the real process 3, not the simulation 20 used for the training).

In each of at least some of the episodes 40, at least one adjustment 22 to the model 29 of the industrial process 3 is input S1 to the simulation 20, whereby the simulated PV values will depend on said adjustment 22.

In each of a plurality of training episodes 40, simulated PV values are input S2 to the agent 2 from the simulation 20 of the industrial process 3, the simulation using a model 29 of said industrial process. Also input S2 are example DV values. Then, in response to the input S2 simulated and example values, the agent 2 outputs S3 MV values. The output S3 MV values are used S4 in said simulation 20 of the industrial process 3, whereby the simulation updates the simulated PV values used in the simulation. A cost of the simulated industrial process when using S4 the MV values is estimated S5. As feedback for the output S3 MV values, the agent is fed S6 a reward 21, wherein the reward is a function of the estimated S5 cost.

In a more general aspect of the present invention, it relates to a method of training a machine learning agent 2 for controlling an industrial process in an industrial plant. The method comprises, to the agent, inputting simulated values of process variables (PV), from a simulation 20 of the industrial process using a model 29 of said industrial process, and example values of disturbance variables (DV). An adjustment 22 is inputted to the simulation, whereby the simulated PV values depend on said adjustment. The agent, in response to the simulated and example values, outputs values of manipulated variables (MV). The MV values are used in the simulation, the simulation updating the simulated PV values. A cost of the simulated industrial process is estimated when using the MV values. As a function of the estimated cost, a reward is fed to the agent.

The present disclosure has mainly been described above with reference to a few embodiments. However, as is readily appreciated by a person skilled in the art, other embodiments than the ones disclosed above are equally possible within the scope of the present disclosure, as defined by the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of using a Reinforcement Learning algorithm to train a machine learning agent for controlling an industrial process in an industrial plant, the method comprising:
for each of a plurality of training episodes:
to the agent, inputting simulated values of process variables from a simulation of the industrial process using a model of the industrial process, which process variables can be sensed or estimated in the plant, and example values of disturbance variables, which may or may not be sensed in the plant and which are external variables which are not controlled;
to the simulation, inputting the example values of the disturbance variables;
the agent, in response to the inputted simulated and example values, outputting values of manipulated variables, which can be actuated in the plant;
using the outputted values of the manipulated variables in the simulation while simulating the disturbance associated with the DV values, the simulation updating the simulated values of the process variables used in the simulation;
estimating a cost of the simulated industrial process when using the values of the manipulated variables; and
as a function of the estimated cost, feeding a reward to the agent;
to obtain the trained agent;
further comprising, in each of at least some of the episodes, to the simulation inputting at least one adjustment of the model of the industrial process, the inputted simulated values of the process variables depending on said adjustment, wherein the at least one adjustment comprises an adjustment of a parameter in the model based on an estimated probability of the parameter assuming different values.

2. The method of claim 1, wherein the estimating of the probability comprises estimating the probability of the parameter assuming different values based on historical data of the industrial process.

3. The method of claim 1, wherein the at least one adjustment comprises an adjustment by adding at least one equation to the model and/or removing at least one equation from the model, and/or adding at least one term to an equation of the model and/or removing at least one term from an equation of the model.

4. The method of claim 1, further comprising using the trained agent for controlling the industrial process in the plant.

5. The method of claim 1, wherein the feeding of the reward comprises calculating the reward based on an economic objective function related to an economic target for the industrial process relative to the estimated cost, and a barrier function related to a predefined constraint for at least one of the process variables and/or a predefined constraint for at least one of the manipulated variables.

6. A system configured for using a Reinforcement Learning algorithm to train a machine learning agent for controlling an industrial process in an industrial plant, the system comprising processing circuitry and storage storing instructions executable by the processing circuitry, wherein the system is operative to perform a method comprising:
for each of a plurality of training episodes:
to the agent, inputting simulated values of process variables from a simulation of the industrial process using a model of the industrial process, which process variables can be sensed or estimated in the plant, and example values of disturbance variables, which may or may not be sensed in the plant and which are external variables which are not controlled;
to the simulation, inputting the example values of the disturbance variables;
the agent, in response to the inputted simulated and example values, outputting values of manipulated variables, which can be actuated in the plant;
using the outputted values of the manipulated variables in the simulation while simulating the disturbance associated with the DV values, the simulation updating the simulated values of the process variables used in the simulation;
estimating a cost of the simulated industrial process when using the values of the manipulated variables; and
as a function of the estimated cost, feeding a reward to the agent;
to obtain the trained agent;
further comprising, in each of at least some of the episodes, to the simulation inputting at least one adjustment of the model of the industrial process, the inputted simulated values of the process variables depending on said adjustment, wherein the at least one adjustment comprises an adjustment of a parameter in the model based on an estimated probability of the parameter assuming different values.

7. A computer program product comprising computer-executable components for causing a system to perform a method when the computer-executable components are run on processing circuitry comprised in the system, the method comprising:
for each of a plurality of training episodes:
to the agent, inputting simulated values of process variables from a simulation of the industrial process using a model of the industrial process, which process variables can be sensed or estimated in the plant, and example values of disturbance variables, which may or may not be sensed in the plant and which are external variables which are not controlled;
to the simulation, inputting the example values of the disturbance variables;
the agent, in response to the inputted simulated and example values, outputting values of manipulated variables, which can be actuated in the plant;
using the outputted values of the manipulated variables in the simulation while simulating the disturbance associated with the DV values, the simulation updating the simulated values of the process variables used in the simulation;
estimating a cost of the simulated industrial process when using the values of the manipulated variables; and
as a function of the estimated cost, feeding a reward to the agent;
to obtain the trained agent;
further comprising, in each of at least some of the episodes, to the simulation inputting at least one adjustment of the model of the industrial process, the inputted simulated values of the process variables depending on said adjustment, wherein the at least one adjustment comprises an adjustment of a parameter in the model based on an estimated probability of the parameter assuming different values.
